(19) United States
(12) Patent Application Publication
(10) Pub. No.: US 2010/0070056 A1
(43) Pub. Date: Mar. 18, 2010

(54) Method for conducting a tournament of games of chance

(76) Inventor: Jack Bertram Coronel, Las Vegas, NV (US)

Correspondence Address: ROBERT RYAN MORISHITA;MORISHITA LAW FIRM, LLC, 8960 WEST TROPICANA AVENUE, SUITE 300, LAS VEGAS, NV, 89147, US

(21) Appl. No.: 12/321,694

(22) Filed: Jan. 22, 2009

Related U.S. Application Data
(63) Continuation-in-part of application No. 12/106,262, filed on Apr. 18, 2008.

(51) Int. Cl. G06F 19/00

(52) U.S. Cl. 700/91

(57) ABSTRACT

A method for conducting a tournament and event consisting of a plurality of tournaments includes conducting at least one game of chance and tracking at least one chance event that may occur in the game of chance. A tournament outcome based on at least one chance event is generated independent of the game outcome. Optionally, the tournament outcome is generated by ranking the players relative to one another based on tracked chance events. Optionally, a plurality of chance events are tracked for each player and the tournament outcome may be generated by defining a weighting for each chance event and calculating a ranking for each player in the tournament based on a weighted score of the tracked chance events and the defined weighting. A tournament reward is issued to at least one of the players based on the tournament outcome independent of the game outcome.

### RELATED APPLICATION DATA

The present application is a continuation-in-part of U.S. patent application Ser. No. 12/106,262, entitled “Method for Conducting a Tournament of Games of Chance,” filed Apr. 18, 2008 by Applicant herein.

### FIELD OF THE INVENTION

The present invention relates to methods for conducting tournaments and events. More particularly, the present invention includes a method for conducting a tournament for players of a game of chance in which the tournament outcome is independent of the game outcome(s) and a method for conducting an event consisting of such tournaments.

### BACKGROUND OF THE INVENTION

It is known in the art to devise tournaments to allow competition in games that typically do not allow for competition. For example, in fishing, tournaments have been devised, such as that shown in Byrne, U.S. Pat. No. 6,587,740, which create a framework within which an essentially non-competitive skill-based sport can played competitively. In Byrne, for example, an angler is rated based on a number of different variables that depend either upon factors under the angler's control, such as the number of fishing trips and length of time spent fishing on each trip, or factors that are related to the angler's skill, such as the size or weight of fish caught in comparison to existing world records.

Other rating systems exist in which skill is a central component. For example, Saidakovsky et al., U.S. Pat. No. 6,604,997, discloses a rating system for video gamers in which the role of skill is emphasized and the role of chance is minimized or eliminated. Specifically, Saidakovsky applies a formula to a player's earned score to generate a final score that rewards skillful play. Such a formula tends to emphasize skill factors such as the time to finish a game, the difficulty of the game, and number of moves used in the game.

Similar to Saidakovsky, Graepel, U.S. Pat. No. 7,050,868, discloses a system for ranking a player based on the player's skill in a skill-based video game. The rating tracks the progress or standing of each player in the gaming environment so that evenly ranked players can be matched up for future games. Saidakovsky, Graepel, and Byrne are similar in that their dependence on skill precludes the application of such tournament methods to games of chance.

In games of chance, the typical tournament is based on the outcome of the game of chance. For example, in a slot tournament, each player's slot machine is loaded with a predetermined starting bankroll. A tournament session is conducted in which all players simultaneously play the slot machines, with winnings being credited to the bankroll and losses being deducted from the bankroll. The winner is determined by comparing the final bankrolls of the players. The player who had the greatest net difference between his winning outcomes and losing outcomes, i.e. the player who had the greatest net winnings, is the winner.

A bingo game, which can be analogized to a type of tournament, also depends on the outcome of the game. That is, of the many players in a bingo game, the winning player is the first player who obtains an outcome on his or her bingo card that matches a predefined pattern. Thus, the winner of the bingo “tournament” is the player who obtains a winning game outcome. While there are methods employed to designate a second place player, a third place player, and so forth, these methods include the calling of additional numbers after a bingo has occurred, with the lower rankings being awarded to the ensuing players to obtain a bingo. In other words, the second place player would be the second player to obtain a game-winning outcome of a bingo, the third place player would be the third player to obtain a game-winning outcome of a bingo, and so forth.

It can be seen, therefore, that there is a need in the art for a tournament applied to a game of chance which produces a tournament outcome that is based on chance, rather than skill, and is independent of the outcome of the game of chance.

### SUMMARY OF THE INVENTION

The present invention includes a method of conducting a tournament for a plurality of players. A tournament includes a plurality of games of chance that is conducted for the players. It is contemplated that the players may play simultaneously or may play separately. Similarly, it is contemplated that the games of chance within a tournament may be conducted using a single set of base rules, i.e. the same type of game, or using multiple different sets of base rules, i.e. different types of games.

The games of chance include at least one chance event. As described in greater detail below, a chance event is an event over which the player exercises no control and which is uninfluenced by the skill of the player. For example, where each game of chance results in a game outcome in the form of a win or loss of game credits, a chance event may include a score based, at least in part, on the net win or loss of game credits over multiple games of chance. In this regard, the chance event is both outside the player's control and independent of any single game outcome.

The chance event(s) is tracked for each player. A tournament outcome based on the tracked chance events is generated independent of any one game outcome. In an optional embodiment, the tournament outcome includes a ranking of at least a portion of the players relative to one another.

A tournament reward is issued to at least one of the players based on the tournament outcome independent of the game outcome.

In another aspect of the present invention, an event is conducted for a plurality of players. The event includes conducting a plurality of tournaments. Optionally, each tournament includes conducting a plurality of games of chance for the players. The plurality of games of chance include at least one chance event and generate a plurality of game outcomes. In one optional embodiment, the game of chance is conducted according to base rules. In one such optional embodiment, all the games of chance within a tournament (or, optionally, across tournaments) are the same game or same type of game. In another such optional embodiment, one or more of the tournaments include multiple different games of chance, e.g. different games of chance conducted according to different base rules. In yet another optional embodiment, the games of chance are uniform within each tournament, but the games differ from tournament to tournament. It is contemplated that the players may play simultaneously or may play separately in time and/or location.

The chance event is tracked for the players. A tournament outcome is generated based on the chance event independent of any one of the game outcomes. For example, in an optional embodiment, the game outcome is a winning or losing game outcome. In one such optional embodiment, the chance event may be a score over multiple game outcomes that is independent of any single game outcome. For example, in one optional embodiment, a score may relate to a net gain or loss of game credits over multiple games of chance.

Optionally, a tournament outcome includes a ranking of at least a portion of the players relative to one another based on the tracked chance event. In one such optional embodiment, play is terminated for players lacking a predetermined ranking according to the tournament outcome such that terminated players are ineligible for a subsequent tournament in the event. In an additional or alternative optional embodiment, a tournament reward is issued to at least one of the players based on the tournament outcome. An election is received from the player to retain the tournament reward or stake at least a portion of the tournament reward in at least one subsequent tournament.

An event outcome is generated based on at least one of the tournament outcomes across the plurality of tournaments. Optionally, the event outcome is based on the cumulative tournament outcomes across the plurality of tournaments. In an optional embodiment, an event reward is issued to at least one of the players based on the event outcome.

### BRIEF DESCRIPTION OF THE DRAWINGS

FIG. 1 is a flowchart of a method according to an embodiment of the present invention;

FIG. 2 is a flowchart of a method according to an embodiment of the present invention;

FIG. 3 is a flowchart of a method according to an embodiment of the present invention.

### DESCRIPTION

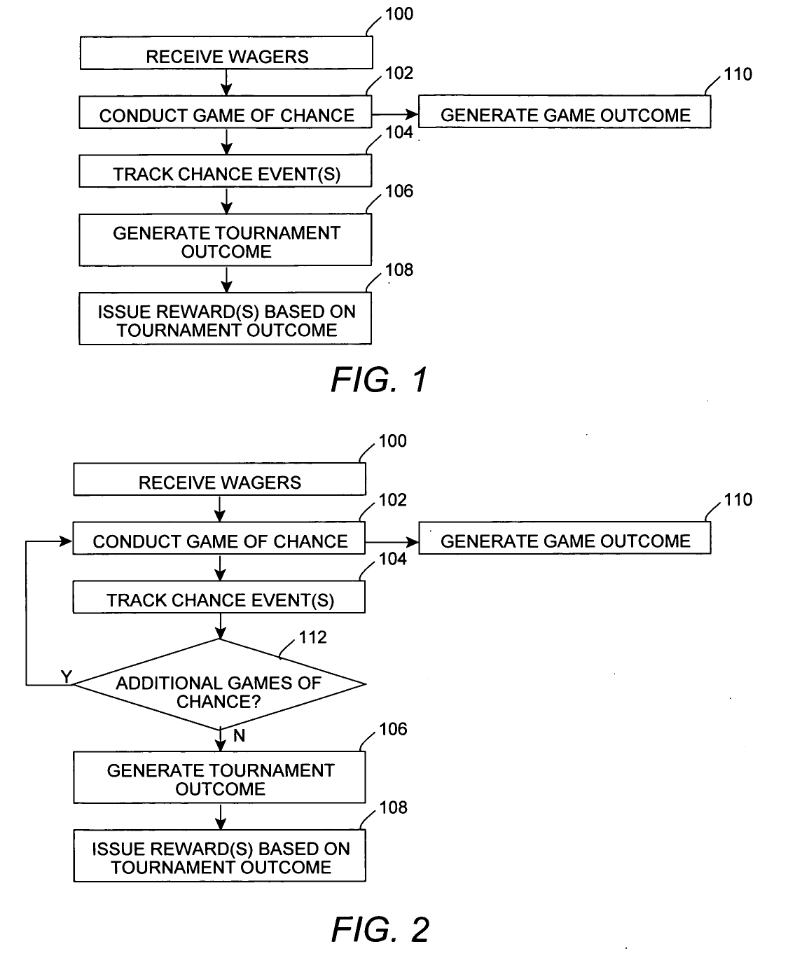

Reference is now made to the figures wherein like parts are referred to by like numerals throughout. Referring generally to FIGS. 1 and 2, the present invention includes various embodiments of a method for conducting a tournament in a game of chance. The tournament method may be applied to any type of game of chance. Thus, although examples are given below describing embodiments of a tournament method applied to specific games, these examples should be interpreted as illustrative rather than limiting. In particular, the method may be applied to games of chance, such as match games like lottery, raffle, pull-tab, bingo, keno, roulette, or the like or dice games like craps, sic bo, or the like, in which a plurality of players play a common game of chance simultaneously. Likewise, the method may be applied to games of chance, such as slot games, video card games, card games, or the like, in which players may play a common game or may play separate games. Similarly, it is contemplated that where players may play separate games, players may play substantially the same game of chance or may play different games of chance in the tournament. Additionally, it is contemplated that the tournament may be conducted to a single game of chance or over multiple games of chance.

Referring to FIGS. 1 and 2, the present method includes conducting 102 at least one game of chance for players. As mentioned above, and discussed in greater detail below, the method may include conducting a single game of chance, as shown in FIG. 1, or conducting multiple games of chance, as shown in FIG. 2, for players by, for example, players playing separate games (such as in a tournament directed to slot games in which each player plays a slot game on a separate slot machine) or players playing a common game multiple times. In either case, additional games of chance 112 are conducted until the tournament is completed, e.g. a particular event occurs, a specified quantity of games is conducted, a specified amount of time elapses, or the like. In such an optional embodiment, it is contemplated that players may play simultaneously, or at different times or over different time segments. For example, a method according to an optional embodiment of the present invention would permit players to participate in a tournament even if the players played the game or games of chance at different times, via different media, e.g. paper cards, Internet, kiosk, gaming machine, or the like, or at different locations, e.g. at different locations within a casino, at different casinos, at different locations other than a casino, or the like. In such an optional embodiment, the occurrence of a designated chance event (described in greater detail below) is tracked for each player so that a tournament outcome can be generated across all the participating players.

In an optional embodiment, consideration may be received from players for participation in the tournament. In an alternate optional embodiment, the tournament may be conducted as a promotion with no consideration required for participation. Where consideration is received 100, the consideration may be cast as a wager, or a tournament entry fee, or the like. As may be appreciated, the basis on which the consideration, if assessed, is calculated. For example, the consideration could be a flat fee or wager, a fee or wager based on the amount of participation (such as a fee or wager assessed per hand, per card, per pay line, or the like) or any other type of fee. It is contemplated that the consideration may be monetary or non-monetary, such as player points. Where the tournament includes multiple games of chance (either multiple different games of chance or multiple iterations of a single game of chance) a fee or wager may be received for each game of chance, or a single fee or wager may be assessed for all games of chance within the tournament.

With reference generally to FIGS. 1 and 2, the game of chance includes at least one chance event and produces 110 a game outcome. As previously mentioned, the present invention may be applied to any game of chance. For example, the invention may be applied to a slot game in which the game outcome occurs when reel symbols are selected to one or more pay lines, a card or tile game in which one or more player hands are dealt and the game outcome occurs when the player hands are compared to one another, a dealer or banker hand, or a standard such as a pay table, a match game such as bingo, keno, roulette, or the like in which a game outcome is generated when a selection set is compared to a player set, a dice game in which a game outcome occurs when the roll of a die or multiple dice is compared to a player-selected prediction or proposition, or the like. of a player selection in a game such as roulette or keno; or any other chance event that may occur.

Alternatively, the chance events may be related to the game outcomes over a series of games, while independent of any single game outcome. Thus, in one example, the game outcome is a winning or losing game outcome, e.g. a winning or losing hand, a winning or losing reel symbol combination, a winning pattern on a Bingo card, a winning number of matches in Keno, or the like. In one such optional embodiment, the chance event may optionally be a score related to the winning or losing outcomes without being dependent on any single game outcome. For example, in one such example, a game outcome may relate to a gain or loss of game credits. In one such optional embodiment, the chance event may optionally be a score based, at least in part, on the net game credits won or lost over the plurality of games of chance. Thus, in one such optional embodiment, the score may be proportional (including a one-to-one relationship) to the net game credits won or lost over a plurality of games of chance so that the chance event is the chance that the player can obtain gain more credits in winning game outcomes than the player loses in losing game outcomes.

In another example, a score may be based, at least in part, on the game outcome in a selected subset (whether deliberately or randomly selected) of a plurality of games so that the chance event is the chance that the player obtained winning game outcomes in the games of the subset. For example, the score may be the net game credits won or lost in every fifth game, e.g. the fifth game, tenth game, fifteenth game, etc., over a plurality of games in a tournament.

In yet another example, the score is based, at least in part, on a weighted average or weighted sum of game outcomes within a tournament so that the chance event is the chance that the player obtained, on balance, winning outcomes to outweigh losing outcomes. It is contemplated that the weighting may be deliberately or randomly determined and may be made express to, or may be kept secret from, the player.

One or more chance events are tracked 104 for each player over the course of the tournament. Based on tracked chance events, a tournament outcome is generated 106. Since chance events are not directly related to the game outcome, the tournament outcome is independent of any single game outcome. In other words, in a method according to an embodiment of the present invention, a player's position in the tournament outcome does not necessarily relate to that player's game outcome(s) obtained in the course of the tournament. That is not to say that a player with a winning game outcome will not be rewarded; in an optional embodiment, a player with a winning game outcome may be rewarded for that game outcome. However, the rewards issued 108 to players based on the tournament outcome will be independent of any single game outcomes and that player will not necessarily be rewarded in the tournament merely because the player obtained a winning game outcome. Rather, for a player with a winning game outcome to be rewarded in the tournament, the player must also have a tournament outcome eligible for a tournament reward.

In an optional embodiment, the tournament outcome is merely a single designated winner who is rewarded. In another optional embodiment, the players are ranked relative to one another and the players are rewarded in descending order, e.g. first place, second place, and so forth.

For example, in an optional embodiment applied to bingo, a number of chance events may be tracked in the course of one or more bingo games. In this example, tracked chance events include the number of incomplete patterns which were one match away from a predefined pattern when a bingo occurs. In an example game in which a first player obtains a bingo with two other incomplete patterns within one match of a bingo, a second player has one incomplete pattern within one match of a bingo when the bingo occurs, and a third player has four incomplete patterns within one match of a bingo when the bingo occurs, the tournament outcome may look substantially as shown in Table 1:

TABLE 1

| Player | Number of Incomplete Patterns | Tournament Outcome |
|---|---|---|
| Third player | 4 | First place |
| First player | 2 | Second place |
| Second player | 1 | Third place |

In the example game summarized in Table 1, the third player may be rewarded for winning the tournament, while the first player may (or may not) be rewarded for having a winning game outcome. As previously mentioned, multiple players may be rewarded in a tournament. If such an optional embodiment were employed in the example of Table 1, perhaps the first player would be rewarded for obtaining second place in the tournament, regardless of whether he or she is also rewarded for obtaining a winning game outcome.

In an optional embodiment, multiple chance events may be tracked in the course of a game in a tournament. In one such optional embodiment, a calculation may be defined to account for each chance event that is tracked. For example, in an optional embodiment, weights may be assigned to each chance event, and the tournament outcome may be determined using a formula that produces a weighted score or weighted average accounting for each chance event based on its defined weighting.

Thus, in a variation on the example given in Table 1, tracked chance events may include the number of incomplete patterns that are one match from completion at the time the game ends, e.g. a bingo occurs, and the ratio of cards with at least one incomplete pattern within one match from completion (also known as “cased” cards). In one such example, the ratio of the cased cards is the weighting that is used to generate a “weighted score” by multiplying the ratio of cased cards by the number of incomplete patterns. In an example of such a game, a first player may obtain a bingo at a point where a first player has eight incomplete patterns across six cards (three of which are cased), a second player has nine incomplete patterns across five cards (four of which are cased), an a third player has nine incomplete patterns across four cards (three of which are cased). In such an example, the tournament outcome may look substantially like that shown in Table 2:

TABLE 2

| | Number of | | | |
|---|---|---|---|---|
| | Incomplete | Ratio of Cards | Weighted | Tournament |
| Player | Patterns | “Cased” | Score | Outcome |
| Second player | 9 | 4/5 | 7.20 | First place |
| Third player | 9 | 3/4 | 6.75 | Second place |
| First player | 8 | 3/6 | 4.00 | Third place |

In the example of Table 2, the second player has a first place tournament outcome, which is independent of the first player's winning game outcome.

Where a tournament consists of multiple games of chance, such as that shown in FIG. 2, a chance event may be tracked over the multiple games. That is, as the games of chance are conducted, at least one chance event used to determine the tournament outcome is tracked. In one such optional embodiment, a chance event may be selected to reflect consistency rather than rare occurrences such as big wins. For example, in a card or tile game tournament, a tracked chance event may be the number of showdowns reached. In this manner, the player who consistently reached the final comparison would be rewarded, even if the player failed to amass the greatest quantity of chips at the end of the tournament. For example, in a card or tile game tournament in which a total of ten games were played a first player may reach eight showdowns, a second player (who amasses the greatest quantity of chips at the end of the ten games) may reach five showdowns, a third player may reach four showdowns, and a fourth player may reach six showdowns. In such an example, the tournament outcome may look substantially like that shown in Table 3:

TABLE 3

| Player | Number of Showdowns | Tournament Outcome |
|---|---|---|
| First player | 8 | First place |
| Fourth player | 6 | Second place |
| Second player | 5 | Third place |
| Third player | 4 | Fourth place |

Thus, in this example, the first player obtains first place in the tournament even though the second player (who finished in third place in the tournament) was the “chip winner.” In this manner, the tournament outcome is independent of the individual game outcomes.

A reward is issued to at least one player based on the tournament outcome. As previously mentioned, in an optional embodiment, multiple players may be rewarded based on the player's rank or rating in the tournament outcome. The reward may take any form, such as a monetary prize, an in-kind prize (for example, a good or service, player points, or entry into other tournaments), or the like. In an optional embodiment, the rating (or player points awarded based on the rating) may be accumulated over time to provide a rating over multiple tournaments. For example, a player with two “first place” ratings and a “second place” rating over three tournaments could claim a higher cumulative rating than a player with a “first place” rating, a “second place” rating, and a “third place” rating over three tournaments.

It is contemplated that non-players of the game of chance may also participate in the tournament. In other words, in an optional embodiment, a participant in the tournament may not be required to be a player of the game of chance. For example, in one optional embodiment, wagers may be received from non-players of a tournament and chance events may be tracked for that non-player participant. Tracked chance events for non-player participants may be generated by one of the players of the game of chance, e.g. a designated player's bingo card(s), a common game shared among multiple non-player participants, e.g. a community bingo card(s) for non-players, a game assigned to, or selected by, the non-player participant that is used only for generating a tournament outcome for the non-player participant, and not a game outcome for the non-player participant, e.g. a non-player participant's bingo card that is excluded from any rewards for a game outcome but eligible for rewards for a tournament outcome, or the like. In one such optional embodiment, non-player participants may be included with players in an overall tournament outcome, or may be separated from players to produce separate tournament outcomes for non-player participants and players.

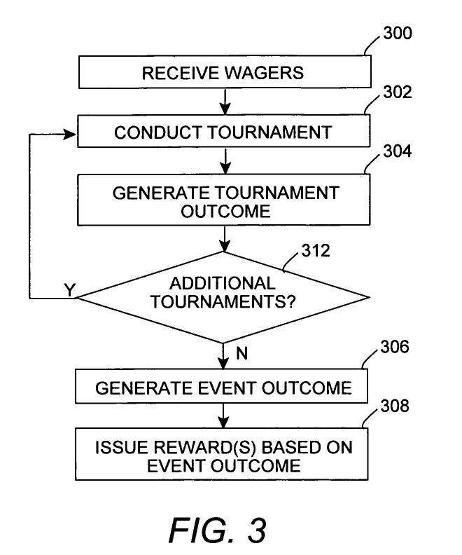

Referring to FIG. 3, multiple tournaments may be conducted 302 in an event. That is, in an optional embodiment, a tournament may be made up of multiple games of chance, and an event may be made up of multiple tournaments. As above, the tournaments may include multiple iterations of a single type of game or single or multiple plays of different types of games. Similarly, each tournament may be directed to the same game, e.g. a Bingo event includes multiple Bingo tournaments, or different tournaments may be directed to different games, e.g. a “pentathlon” event may include a Bingo tournament, a Keno tournament, a slot tournament, a poker tournament, and a Blackjack tournament. As above, the tournaments may be conducted for all players simultaneously or players may be permitted to enter and play at different times and/or locations from other competitors in the events and/or tournaments.

The tournaments may be conducted 302 in any manner discussed above. Specifically, one or more chance events are tracked over the games of chance within a tournament. As discussed above, the chance events may be relate to the individual game or may be cumulative over a plurality of games. A tournament outcome 304 independent of any one game outcome is generated based on the chance event(s). In conducting the event, the process is repeated 312 until the tournaments within the event are conducted.

In conducting the tournaments, the tournaments or the event may conducted as promotional with no wagering or entry fee required. For example, a player may be rewarded with participation in an event for a predetermined level of play or induced into a casino with a free entry into an event.

In another optional embodiment, a wager or entry fee may be received 300 for the event. It is contemplated that the wager or entry fee may be related only to the event or may be related to a separate game, tournament, or event. For example, in one such optional embodiment, the player may be permitted to buy entry into an event by paying a premium in another game.

In yet another optional embodiment, a wager or entry fee may be received for each individual tournament within an event. That is, in an optional embodiment, one of the conditions for participation in a tournament within an event may be that a wager is received for the tournament or for the games of chance within the tournament. In one optional embodiment, the tournaments may be interrelated in the wagering. For example, as discussed above, each tournament may include a tournament outcome and a tournament reward. In one such optional embodiment, a player receiving a tournament reward may be permitted to stake the tournament reward from one tournament on a separate tournament. That is, the player may elect to use a tournament reward from one tournament as the wager (or to supplement a wager) for another tournament within the event. In a related embodiment, the player may be required to elect to accept the tournament reward or forfeit the tournament reward in exchange for continuing in the event.

An event outcome may be generated 306 based on one or more of the tournament outcomes. In this sense, the event is a tournament of tournaments. The event outcome may be generated in many different ways. For example, in an optional embodiment in which tournament outcomes include rankings of players, the event outcome may be a composite or cumulative ranking based on the rankings within individual tournament outcomes. Thus, a player who ranks first in each of five tournament outcomes within an event would be ranked first in an event outcome. For players in an event in which the tournament outcomes are less uniform, the rankings could be determined in many different ways. For example, the rankings could be based on the number of first place finishes in tournament outcomes, the player's ranking in a specific tournament outcome, the overall sum of rankings in tournament outcomes, a weighted sum of rankings in tournament outcomes, an average ranking in the tournament outcomes, a weighted average ranking in the tournament outcomes, or the like.

In an additional or alternative optional embodiment in which tournament outcomes include a score (in place of, or in addition to, a ranking), the event outcome may be a composite or cumulative score based on the scores within individual tournament outcomes. For example, the rankings could be based on the player's score in an individual tournament outcome, the overall sum of scores in tournament outcomes, a weighted sum of scores in tournament outcomes, an average score in the tournament outcomes, a weighted average score in the tournament outcomes, or the like.

In an optional embodiment, the event may be conducted such that players are eliminated at one or more points during the event. For example, where one or more of the tournament outcomes include a ranking of players, as discussed in greater detail above, players who lack a predetermined ranking may be eliminated from continued play in the event, i.e. eliminated from play in subsequent tournaments in the event. For example, an event may consist of five tournaments, with players finishing in the bottom half of each tournament being eliminated from the event.

An event reward is issued 308 to at least one player based on the event outcome. The event reward may take any form, including forms such as cash, game credits, “free play,” player loyalty points, entry into other tournaments or events, or the like.

While certain embodiments of the present invention have been shown and described it is to be understood that the present invention is subject to many modifications and changes without departing from the spirit and scope of the invention presented herein.

I claim:

1. A method of conducting a tournament for a plurality of players comprising:
conducting a plurality of games of chance for said players, said games of chance including at least one chance event, said games of chance generating a plurality of game outcomes;
tracking said at least one chance event for each said player;
generating a tournament outcome based on said at least one chance event independent of any one of said game outcomes; and
issuing a tournament reward to at least one of said players based on said tournament outcome independent of any one of said game outcomes.

2. The method of claim 1 wherein each said game outcome is a win or loss of game credits and said chance event is a score based, at least in part, on said net game credits won or lost over said plurality of games of chance.

3. The method of claim 1 wherein said step of generating a tournament outcome comprises ranking said players relative to one another based on said tracked chance events and said step of issuing said tournament reward comprises rewarding at least one of said players based on said ranking.

4. The method of claim 1 wherein said step of conducting a game of chance comprises conducting a common game of chance simultaneously for said plurality of players.

5. The method of claim 1 wherein said step of conducting a game of chance comprises conducting a separate game of chance for each player.

6. A method of conducting an event for a plurality of players comprising:
conducting a plurality of tournaments, each said tournament comprising:
conducting a plurality of games of chance for said players, said plurality of games of chance including at least one chance event, said plurality of games of chance generating a plurality of game outcomes;
tracking said at least one chance event for each said player; and
generating a tournament outcome based on said at least one chance event independent of any one of said game outcomes;
generating an event outcome based on at least one of said tournament outcomes across said plurality of tournaments; and
issuing an event reward to at least one of said players based on said event outcome.

7. The method of claim 6 wherein said step of generating a tournament outcome comprises ranking at least a portion of said players relative to one another based on said at least one tracked chance event.

8. The method of claim 7 wherein each tournament further comprises terminating play for players lacking a predetermined ranking according to said tournament outcome such that terminated players are ineligible for a subsequent tournament in said event.

9. The method of claim 6 wherein each said game outcome is a win or loss of game credits and said chance event is a score based, at least in part, on said net game credits won or lost over said plurality of games of chance.

10. The method of claim 6 wherein said step of conducting a game of chance comprises conducting a common game of chance simultaneously for said plurality of players.

11. The method of claim 6 wherein said step of conducting a game of chance comprises conducting a separate game of chance for each player.

12. The method of claim 6 wherein each said game of chance is conducted according to base rules and said step of conducting said plurality of tournaments comprises conducting at least two different games of chance according to different base rules in at least one of said tournaments.

13. The method of claim 6 wherein each said game of chance is conducted according to base rules and said step of conducting said plurality of tournaments comprises conducting at least a first tournament and a second tournament different from said first tournament, such that the games of chance conducted within said first tournament are conducted according to different base rules from the games of chance within said second tournament.

14. A method of conducting an event for a plurality of players comprising:
serially conducting a plurality of tournaments, each said tournament comprising:
conducting a plurality of games of chance for said players, said plurality of games of chance including at least one chance event, said plurality of games of chance generating a plurality of game outcomes;
tracking said at least one chance event for each said player; and
generating a tournament outcome based on said at least one chance event independent of any one of said game outcomes, said tournament outcome including a ranking of at least a portion of said players relative to one another; and
terminating play for players lacking a predetermined ranking according to said tournament outcome such that terminated players are excluded from any subsequent tournaments in said event;
generating an event outcome based on said cumulative tournament outcomes across said plurality of tournaments; and
issuing an event reward to at least one of said players based on said event outcome.

15. The method of claim 14 wherein each said game outcome is a win or loss of game credits and said chance event is a score based, at least in part, on said net game credits won or lost over said plurality of games of chance.

16. The method of claim 14 wherein said step of conducting a game of chance comprises conducting a common game of chance simultaneously for said plurality of players.

17. The method of claim 14 wherein said step of conducting a game of chance comprises conducting a separate game of chance for each player.

18. The method of claim 14 wherein each said game of chance is conducted according to base rules and said step of conducting said plurality of tournaments comprises conducting at least two different games of chance according to different base rules in at least one of said tournaments.

19. The method of claim 14 wherein each said game of chance is conducted according to base rules and said step of conducting said plurality of tournaments comprises conducting at least a first tournament and a second tournament different from said first tournament, such that the games of chance conducted within said first tournament are conducted according to different base rules from the games of chance within said second tournament.

20. The method of claim 14 wherein said step of conducting each said tournament further comprises:
issuing a tournament reward to at least one of said players based on said tournament outcome; and
receiving from said player an election to retain said tournament reward or stake at least a portion of said tournament reward in at least one subsequent tournament.
